(19) United States
(12) Patent Application Publication
(10) Pub. No.: US 2025/0229383 A1
(43) Pub. Date: Jul. 17, 2025

(54) DEVICE FOR CLAMPING WORKPIECES ON MACHINE TOOLS

(71) Applicant: Hydroblock S.r.l., Reggio Emilia, Reggio Emilia (IT)

(72) Inventor: Davide ZANNI, Reggio Emilia, Reggio Emilia (IT)

(73) Assignee: Hydroblock S.r.l., Reggio Emilia, Reggio Emilia (IT)

(21) Appl. No.: 18/876,700

(22) PCT Filed: Jun. 22, 2023
(86) PCT No.: PCT/IB2023/056451

§ 371 Date: Dec. 19, 2024

(30) Foreign Application Priority Data
Jun. 27, 2022 (IT) 102022000013585

(51) Int. Cl. B25B 5/16

(52) U.S. Cl. CPC B25B 5/163

(57) ABSTRACT

The device (1) for clamping workpieces on machine tools comprises:
a basic body (2);
gripping means (7) associated with the basic body (2) and movable between a clamping configuration and a release configuration;
a movement unit (8) which is associated with the basic body (2) and is adapted to move the gripping means (7) between the clamping configuration and the release configuration, comprising:
   a first slider (9a);
   a first clamping piston (11a) associated with the first slider (9a);
   a first release piston (12a) associated with the first slider (9a);
   a second slider (9b);
   a second clamping piston (11b) associated with the second slider (9b);
   a second release piston (12b) associated with the second slider (9b); and
   a friction compensation assembly (30, 31) associated with the clamping pistons (11a, 11b).

### TECHNICAL FIELD

The present invention relates to a device for clamping workpieces on machine tools.

### BACKGROUND ART

As is well known, in mass production of mechanical workpieces which require machining at the machine tool, there is widespread use of highly automated systems wherein one or more machine tools are electronically controlled by a processing and control unit and one or more anthropomorphic robots bring the workpieces to be machined to the machine tools, where special clamping devices, either hydraulic or pneumatic, take over the workpiece and clamp it in place to allow the machining thereof.

When machining is complete, the aforementioned clamping devices release the machined workpiece, which is removed once again by the robots.

A special type of clamping device fulfills its purpose by means of a pair of jaws moved by hydraulic drives between a clamping configuration, wherein the jaws are mutually moved close and clamp the workpiece, and a release configuration, wherein the jaws are mutually moved away and release the workpiece.

Specifically, the aforementioned hydraulic drives comprise two movement assemblies, each of which is associated with a respective jaw and comprises:
a slider, attached to the jaw and sliding locked together therewith along a direction of work; and
two hydraulic pistons, mounted inside respective cylinders, between which the slider is positioned, the latter sliding along the direction of work as a result of the operation of the hydraulic pistons.

In the present case, the pistons allow, thanks to the thrust exerted by a pressurized hydraulic fluid, the sliders to slide along opposite ways of their relevant directions of work, so as to move the jaws attached thereto between the clamping configuration and the release configuration.

In actual facts, of the four total pistons, two are operable to push the jaws mutually close to each other, arranging them in a clamping configuration, while the other two are operable to push the jaws mutually away from each other, arranging them in a release configuration.

Since the aforementioned pistons are of the hydraulic type, the known clamping devices are also provided with special seals (e.g., of the O-ring type), fitted on the pistons themselves in predefined positions in order to prevent unwanted leakage of hydraulic fluid under pressure.

In detail, these seals are designed to flatten during the assembly of the pistons in their respective cylinders, expanding in a radial pattern; thanks to this characteristic, the seals adhere to the walls of the cylinder and actually achieve a watertight seal within the latter.

All that said, it is important to draw attention to the fact that the jaws must be capable of exerting even very large clamping forces on the workpiece.

This need is particularly felt, e.g., in those industries where the continuous need to optimize production cycles has led to the use of tools operating at very high speeds, unloading very large forces and vibrations onto the workpiece that must be offset by the clamping devices.

In a large number of industries, it is also becoming increasingly common to use particularly lightweight materials such as aluminum, which, however, during machining on the machine tool are not capable of ensuring the same strength as materials such as cast iron and steel.

It is therefore necessary for the jaws, in addition to exerting a very high force, to rest on the workpiece with great accuracy, precision and in a repeatable manner whenever a new workpiece is mounted on the machine tool; otherwise, in fact, the great force exerted by the jaws can cause the workpieces to deform, which compromises the quality of machining and the risk of obtaining out-of-tolerance workpieces.

However, this important prerogative is not met at all by the known clamping devices.

In this regard, great consideration should be given to the fact that the seals fitted on the hydraulic pistons always exert a certain resistance to the sliding of the latter and that this resistance has, not infrequently, different intensities between one piston and another.

The resistance offered to sliding by the seals is, in fact, highly dependent on the degree of crushing of the same, which crushing proves, in actual facts, to vary somewhat from seal to seal, even in the cases where the latter are apparently identical to each other and are compressed to substantially the same extent.

Different frictional forces evidently result in different pressurization timings of the hydraulic pistons, with the result that one of the two jaws, specifically the one associated with the piston on which less friction operates, ends up resting on the workpiece before the other.

This operational inaccuracy proves to be exceedingly inconvenient because it results in the jaw that first contacts the workpiece applying particularly strong forces to the workpiece, which puts the structural integrity thereof at serious risk. In light of this, it is easy to appreciate that the jaw clamping devices are susceptible to refinements.

### DESCRIPTION OF THE INVENTION

The main aim of the present invention is to devise a device for clamping workpieces on machine tools with precise and reliable operation which allows the jaws to be laid substantially simultaneously on a workpiece, clamping it stably on a machine tool without deforming it.

Another object of the present invention is to devise a device for clamping workpieces on machine tools which allows the aforementioned drawbacks of the prior art to be overcome within the framework of a simple, rational, easy and efficient to use as well as affordable solution.

The aforementioned objects are achieved by this device for clamping workpieces on machine tools having the characteristics of claim 1.

### BRIEF DESCRIPTION OF THE DRAWINGS

Other characteristics and advantages of the present invention will become more apparent from the description of a preferred, but not exclusive, embodiment of a device for clamping workpieces on machine tools, illustrated by way of an indicative yet non limiting example, in the accompanying tables of drawings in which:

FIG. 1 is an axonometric view of the device according to the invention;

FIG. 2 is an exploded view of the device according to the invention;

FIG. 3 is a top view of the device according to the invention;

FIG. 4 is a front view of the device according to the invention;

FIG. 5 is a sectional view, along the V-V plane of FIG. 3, of the device according to the invention;

FIG. 6 is a sectional view, along the VI-VI plane of FIG. 4, of the device according to the invention.

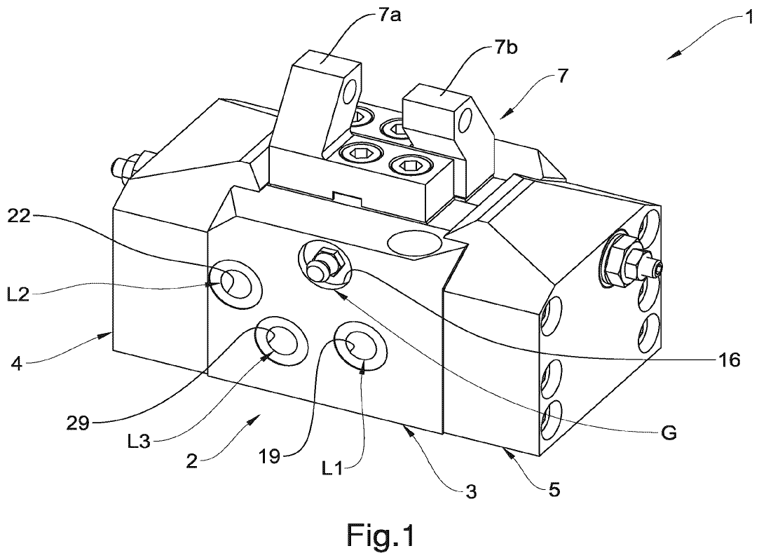

### EMBODIMENTS OF THE INVENTION

With particular reference to these figures, reference numeral 1 globally denotes a device for clamping workpieces on machine tools.

The device 1 for clamping workpieces on machine tools first comprises at least one basic body 2 which can be fastened to a machine tool.

The basic body 2 comprises, in turn, at least a central block 3, at least a first sidewall 4 and a second sidewall 5, the latter being coupled to the central block 3 in a removable manner.

Specifically, in an assembly configuration of the device 1 wherein its constituent components are mutually assembled, the central block 3 is coupled to the sidewalls 4, 5 by interposition of a plurality of connecting elements 6 (e.g., screws or the like).

Specifically, the first sidewall 4 and second sidewall 5 comprise first connection holes 4a and second connection holes 5a respectively, wherein the connecting elements 6 can be fitted to connect the sidewalls 4, 5 to the central block 3.

So, in case it becomes necessary to maintain/replace one or more of the constituent components of the device 1, simply remove the connecting elements 6 and detach, by doing so, one of the sidewalls 4, 5 or both sidewalls 4, 5 from the central block 3.

The device 1 then comprises:
gripping means 7 of a workpiece to be machined associated with the basic body 2, comprising at least a first gripping jaw 7a and at least a second gripping jaw 7b and movable between at least one clamping configuration of the workpiece, wherein the gripping jaws 7a, 7b are mutually approached, and at least one release configuration of the workpiece, wherein the gripping jaws 7a, 7b are mutually moved away with respect to the clamping configuration.
at least one movement unit 8 which is associated with the basic body 2 and is adapted to move the gripping means 7 between the clamping configuration and the release configuration, comprising:
   at least one first slider 9a sliding along at least one first direction of work D1 and associated with the first gripping jaw 7a; and
   at least one second slider 9b sliding along at least a second direction of work D2 parallel to the first direction of work D1 and associated with the second gripping jaw 7b.

Specifically, the gripping jaws 7a, 7b are attached to the respective sliders 9a, 9b and slide locked together with the latter along their respective directions of work D1, D2.

In addition, the sliders 9a, 9b are associated with the central block 3 and are, therefore, positioned between the two sidewalls 4, 5.

In this regard, the central block 3 is provided with at least one guiding element 10 with which the sliders 9a, 9b are associated along their respective directions of work D1, D2 in a sliding manner.

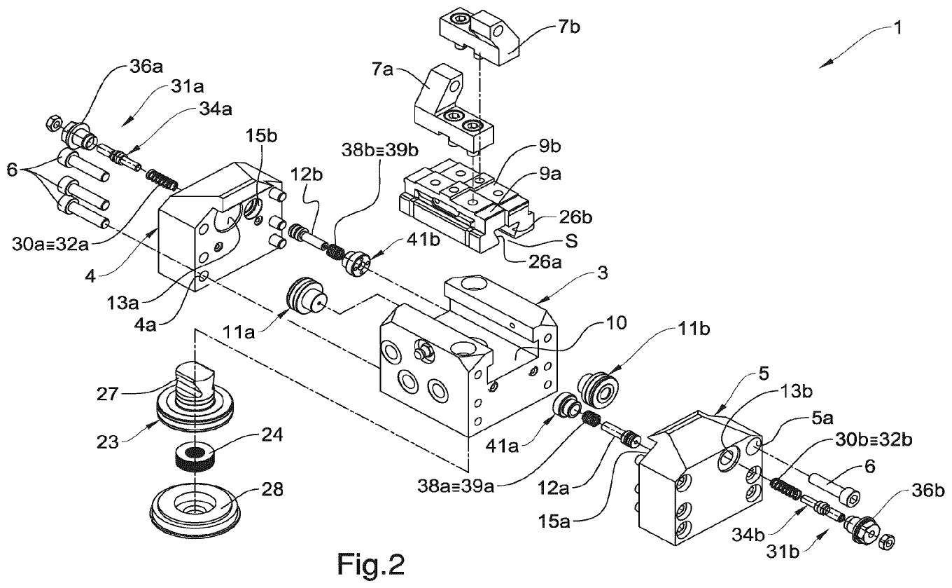

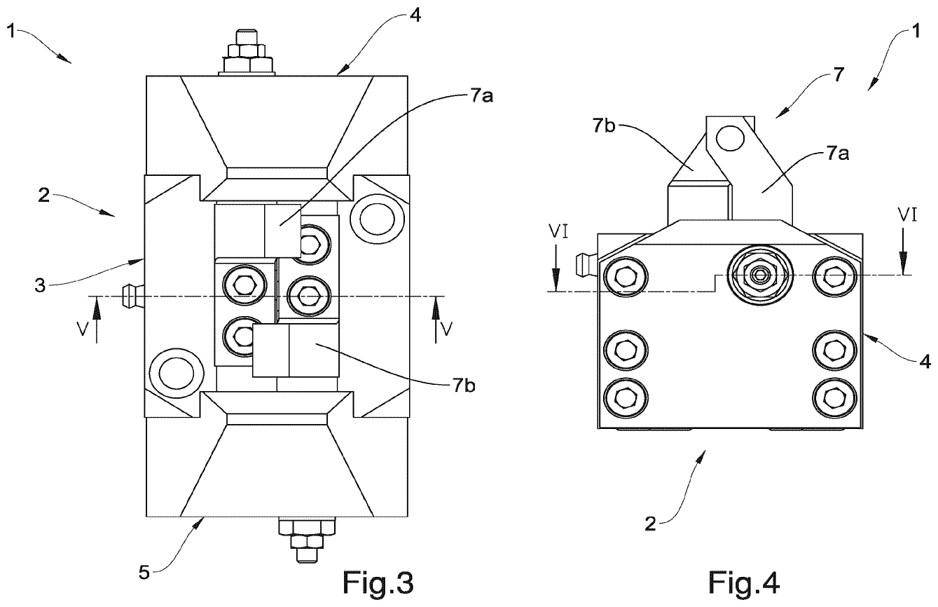

Specifically, as visible in FIG. 2, the guiding element 10 is substantially a cavity, cut out on the central block 3 in a direction parallel to the directions of work D1, D2, within which the sliders 9a, 9b are housed in a sliding manner.

In particular, the guiding element 10 has a substantially complementary conformation to that of the sliders 9a, 9b and thus allows smooth and precise sliding of the latter along their respective directions of work D1, D2.

To enable the movement of the first slider 9a along the first direction of work D1, the movement unit 8 comprises:
at least one first clamping piston 11a operatively associated with the first slider 9a and movable, due to the thrust of at least one pressurized fluid, to allow the first slider 9a and the first gripping jaw 7a associated thereto to slide along at least one first way of clamping B1 moving close to the second gripping jaw 7b;
at least one first release piston 12a operatively associated with the first slider 9a and movable, due to the thrust of the pressurized fluid, to allow the first slider 9a and the first gripping jaw 7a to slide along at least one first way of release R1, opposite the first way of clamping B1, away from the second gripping jaw 7b.

In actual facts, pressurizing the first clamping piston 11a and the first release piston 12a with the pressurized fluid results in them being moved along opposite ways of the first direction of work D1 (i.e., the first way of clamping B1 and the first way of release R1), dragging the first slider 9a and, consequently, the first gripping jaw 7a by sliding.

In this regard, it is important to specify that, in the context of this disclosure, “pressurized fluid” means any fluid in a liquid (and therefore ideally incompressible) or gaseous (and therefore compressible) state used as a carrier medium for the transport of energy in a hydraulic or pneumatic circuit; preferably the pressurized fluid consists of a traditional mineral oil but alternative embodiments wherein it may be synthetic oil, vegetable oil, water, air or the like cannot be ruled out.

This means that, preferably, the first clamping piston 11a and the first release piston 12a are of the type of hydraulic pistons and that it cannot, however, be ruled out that the latter may be, e.g., of the type of pneumatic pistons (in case the pressurized fluid is air) or of the type of hydraulic pistons (in case the pressurized fluid is water).

In addition, it is also specified that, taking into account the presence in the device 1 of different parts in contact with the pressurized fluid, special seals are provided which are arranged at different points of the device 1 which, for simplicity of representation, have been commonly identified by reference numeral 14.

All that said, detailing the components just mentioned in more detail, it is good to explain that the first clamping piston 11a is housed at least partly within the first sidewall 4.

Similarly, the first release piston 12a is housed at least partly within the second sidewall 5.

In this regard, the first sidewall 4 and the second sidewall 5 are provided respectively, with at least a first inner housing 13a wherein the first clamping piston 11a is at least partly fitted, and at least a second inner housing 13b of the first release piston 12a wherein the second clamping piston 11b is at least partly fitted.

The first housing 13a and the second housing 13b substantially represent the cylinders within which the first clamping piston 11a and the first release piston 12a slide, respectively.

The movement unit 8 also comprises:
at least one second clamping piston 11b operatively associated with the second slider 9b and movable, due to the thrust of the pressurized fluid, to allow the second slider 9b and the second gripping jaw 7b to slide along at least one second way of clamping B2 moving close to the first gripping jaw 7a;
at least one second release piston 12b operatively associated with the second slider 9b and movable, due to the thrust of the pressurized fluid, to allow the second slider 9b and the second gripping jaw 7b to slide along at least one second way of release R2, opposite the second way of clamping B2, moving away from the first gripping jaw 7a.

In actual facts, pressurizing the second clamping piston 11b and the second release piston 12b with the pressurized fluid results in them being moved along opposite ways of the second direction of work D2 (i.e., the second way of clamping B2 and the second way of release R2), dragging the second slider 9b by sliding and, consequently, the second gripping jaw 7b.

In much the same way as previously stated, the second clamping piston 11b and the second release piston 12b are preferably of the type of hydraulic pistons, but it cannot, however, be ruled out that they may be of the type of pneumatic pistons (in case the pressurized fluid is air) or hydraulic pistons (in case the pressurized fluid is water).

Regarding the location of the newly introduced components, the second clamping piston 11b is housed at least partly within the first sidewall 4, while the second release piston 12b is housed at least partly within the second sidewall 5.

In this regard, the first sidewall 4 and the second sidewall 5 are provided with at least one first inner seat 15a of the first release piston 12a and with at least one second inner seat 15b of the second release piston 12b, respectively.

The first seat 15a and the second seat 15b substantially represent the cylinders inside which the first release piston 12a and the second release piston 12b slide, respectively.

Having introduced the main components for the movement of the gripping means 7, it is useful to make explicit that, to arrange the latter in a clamping configuration, the first clamping piston 11a is moved along the first way of clamping B1 of the first direction of work D1, thus allowing the first slider 9a and the first gripping jaw 7a associated therewith to slide in that way.

At the same time, the second clamping piston 11b is simultaneously moved along the second way of clamping B2 of the second direction of work D2 to make the second slider 9b and the second gripping jaw 7b associated therewith to slide in that way.

From this it can be inferred that the first way of clamping B1 and the second way of clamping B2 are opposite each other.

Similarly, to arrange the gripping means 7 in a release configuration, the first release piston 12a is moved along the first way of release R1 of the first direction of work D1, thus allowing the first slider 9a and the first gripping jaw 7a associated therewith to slide in that way.

At the same time, the second release piston 12b is also simultaneously moved along the second way of release R2 of the second direction of work D2 to make the second slider 9b and the second gripping jaw 7b associated therewith to slide in that way.

From this it can be inferred that the first way of release R1 and the second way of release R2 are opposite each other.

It follows that the first way of clamping B1 and the second way of release R2 have the same way and that the second way of clamping B2 and the first way of release R1 also have the same way.

To reduce the friction operating on the sliders 9a, 9b during the sliding just described, the movement unit 8 advantageously comprises at least one line of lubrication G connected to the first slider 9a and to the second slider 9b which is adapted to lubricate the latter with at least one lubricating compound (e.g., a high-viscosity lubricant of the type of grease or the like).

Specifically, the line of lubrication G is provided with at least one external access port 16 cut out on the side surface of the central block 3 through which the lubricating compound can be inserted.

Thus, the line of lubrication enables efficient sliding of the sliders 9a, 9b along their respective directions of work D1, D2, dramatically lowering the friction operating on the latter.

Continuing to describe in detail the movement unit 8, it is important to add that it comprises:
at least one first inlet chamber 17a of the pressurized fluid bounded by the first clamping piston 11a and by at least one first bottom wall 18a; and
at least one second inlet chamber 17b of the pressurized fluid bounded by the second clamping piston 11b and by at least one second bottom wall 18b.

In particular, the movement unit 8 also comprises at least a first line of circulation L1 of the pressurized fluid connected to the first inlet chamber 17a and to the second inlet chamber 17b and adapted to at least partly fill the latter with the pressurized fluid.

Specifically, the first line of circulation L1 is provided with at least one relevant first outer supply inlet 19 made on the side surface of the central block 3 and employable to at least partly fill the first line of circulation L1 with the pressurized fluid.

Therefore, to arrange the gripping means 7 in a clamping configuration, the pressurized fluid is introduced into the first line of circulation L1 through the first supply inlet 19.

The pressurized fluid is, in this way, conveyed into the first inlet chamber 17a and into the second inlet chamber 17b, exerting a thrust force on the first clamping piston 11a and on the second clamping piston 11b which allows the first slider 9a to slide in the first way of clamping B1 and the second slider 9b to slide in the second way of clamping B2.

Again, the movement unit 8 comprises:
at least one first introduction chamber 20a of the pressurized fluid bounded by the first release piston 12a and by at least one first bottom surface 21a;
at least one second introduction chamber 20b of the pressurized fluid bounded by the second release piston 12b and by at least one second bottom surface 21b.

Quite similarly to what has been described above, the movement unit 8 also comprises at least one second line of circulation L2 of the pressurized fluid connected to the first introduction chamber 20a and to the second introduction chamber 20b and adapted to at least partly fill the latter with the pressurized fluid.

Specifically, the second line of circulation L2 is provided with at least one relevant second outer supply inlet 22 made on the side surface of the central block 3 and usable to at least partly fill the second line of circulation L2 with the pressurized fluid.

Therefore, to arrange the gripping means 7 in the release configuration, the pressurized fluid is introduced into the second line of circulation L2 through the second supply inlet 22.

The pressurized fluid is, in doing so, conveyed into the first introduction chamber 20a and into the second introduction chamber 20b, exerting a thrust force on the first release piston 12a and on the second release piston 12b that allows the first slider 9a to slide in the first way of release R1 and the second slider 9b to slide in the second way of release R2.

In the switch from the release configuration to the clamping configuration, the pressurized fluid is discharged from the introduction chambers 20a, 20b, is conveyed from the second line of circulation L2 to the first line of circulation L1 (e.g., by means of special hydraulic connections) and is, finally, fed into the inlet chambers 17a, 17b.

In this way, it is possible to cancel the thrust force operating on the release pistons 12a, 12b and transfer it onto the clamping pistons 11a, 11b by reversing the way of sliding of the sliders 9a, 9b (i.e., by stopping their sliding along the ways of release R1, R2 and imposing it along the ways of clamping B1, B2).

In the opposite case, i.e., in the switch from the clamping configuration to the release configuration, the pressurized fluid is discharged from the inlet chambers 17a, 17b, is conveyed from the first line of circulation L1 to the second line of circulation L2 (e.g., by means of special hydraulic connections) and is, finally, fed into the introduction chambers 20a, 20b.

In this way, it is possible to cancel the thrust force operating on the clamping pistons 11a, 11b and transfer it to the release pistons 12a, 12b, by reversing the way of sliding of the sliders 9a, 9b (i.e., stopping their sliding along the ways of clamping B1, B2 and imposing it along the ways of release R1, R2).

To ensure that the workpiece remains firmly secured when the gripping means 7 are in the clamping configuration, the device 1 comprises stopping means 23, 24 associated with the basic body 2.

In this regard, the central block 3 is provided with at least one recess 25 within which the stopping means 23, 24 are arranged.

Specifically, the stopping means 23, 24 comprise at least one stopping piston 23 which is movable along at least one direction of stopping A substantially orthogonal to the directions of work D1, D2 and is adapted to clamp the sliders 9a, 9b by friction in the clamping configuration.

Specifically, the direction of stopping A is orthogonal to the first direction of work D1 and to the second direction of work D2.

In accordance with the preferred embodiment, the first slider 9a and the second slider 9b comprise at least one first indented portion 26a and at least one second indented portion 26b respectively, where the indented portions 26a, 26b are juxtaposed with each other to define at least an internal space S between the sliders 9a, 9b.

As visible in FIG. 2, the space S develops in the direction parallel to the directions of work D1, D2.

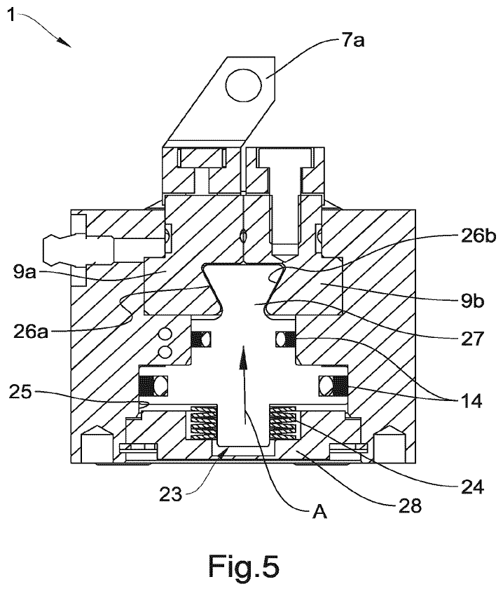

Again, the stopping piston 23 is provided with at least one enlarged portion 27 which can be inserted into the space S to clamp the sliders 9a, 9b (see FIG. 5 in this regard).

Specifically, the enlarged portion 27 has the so-called “dovetail” conformation. To insert the enlarged portion 27 into the space S and clamp, in doing so, the sliders 9a, 9b, the stopping means 23, 24 comprise at least one elastically compressible thrust element 24 which is positioned between one end of the stopping piston 23 and the basic body 2 and is adapted to impart on the stopping piston 23 at least one direct thrust force along the direction of stopping A.

Precisely, as visible in FIG. 5, the thrust element 24 is positioned between one end of the stopping piston 23 and at least one bottom 28 of the basic body 2 arranged to close the recess 25, isolating it from the outside.

Conveniently, the thrust element 24 is of the type of a spring, such as e.g. a disc spring.

In order to move the enlarged portion 27 away from the space S and release, by doing so, the sliders 9a, 9b, the stopping means 23, 24 comprise a relevant third line of circulation L3 of the pressurized fluid.

Specifically, the third line of circulation L3 is provided with at least a relevant third external supply inlet 29 formed on the side surface of the central block 3 and usable to at least partly fill the third line of circulation L3 with the pressurized fluid.

The third line of circulation L3 terminates at the end of the stopping piston 23 opposite the thrust element 24; in this way, the force generated by the pressurized fluid compresses the thrust element 24 as it moves close to the bottom 28, reducing the length thereof and thus allowing the enlarged portion 27 to be disengaged from the space S.

After the pressurized fluid has been discharged from the third line of circulation L3, the compressive force exerted by the pressurized fluid on the thrust element 24 is lost and the latter therefore pushes the stopping piston 23 along the direction of stopping A, inserting the enlarged portion 27 thereof within the space S.

From what has just been described, it is easy to appreciate that, in the release configuration, the pressurized fluid is introduced both along the second line of circulation L2 (so that it can fill the introduction chambers 20a, 20b) and along the third line of circulation L3 (so that it can disengage the enlarged portion 27 from the space S).

On the other hand, the pressurized fluid is introduced along only the first line of circulation L1 (so that it can fill the inlet chambers 17a, 17b and the enlarged portion 27 can fit into the space S) in the clamping configuration.

The fact is emphasized that providing stopping means 23, 24 of the sliders 9a, 9b in the clamping configuration turns out to be a rather advantageous technical expedient to ensure that the gripping jaws 7a, 7b remain firmly in prehension of the workpiece.

It is easy to appreciate how this fact, by averting the possibility of unwanted movement of the gripping jaws 7a, 7b in the clamping configuration, ensures effective, precise and accurate operation of the device 1.

According to the invention, the movement unit 8 comprises at least one friction compensation assembly 30, 31 associated with the clamping pistons 11a, 11b.

Specifically, the friction compensation assembly 30, 31 is adapted to compensate for the friction operating on the clamping pistons 11a, 11b at the sliding thereof along the ways of clamping B1, B2 of the relevant directions of work D1, D2.

In fact, as explained, the presence of seals 14 results in the presence of frictional forces of different intensities between the clamping pistons 11a, 11b and, therefore, the serious possibility that one of the gripping jaws 7a, 7b will impact the workpiece before the other.

As will be deeply explained in the remainder of this disclosure, providing a friction compensation assembly 30, 31 completely cancels out this inconvenient possibility by allowing, therefore, to obtain a device 1 perfectly capable of simultaneously laying its gripping jaws 7a, 7b on the workpiece, stably clamping the latter on a machine tool without deforming it.

Beginning to detail the friction compensation assembly 30, 31 it is good, first of all, to say that it comprises first loading means 30a associated with the first clamping piston 11a and second loading means 30b associated with the second clamping piston 11b, where the loading means 30 are adapted to exert on the clamping pistons 11a, 11b at least one preload force having a direction substantially parallel to the directions of work D1, D2 and a way concordant with the ways of clamping B1, B2.

This means that the first loading means 30a exert on the first clamping piston 11a a preload force parallel to the first direction of work D1 and having a way concordant to the first way of clamping B1, while the second loading means 30b exert on the second clamping piston 11b a preload force parallel to the second direction of work D2 and having a way concordant to the second way of clamping B2.

Specifically:
the first loading means 30a comprise at least one elastically compressible first loading element 32a which is arranged to abut on the first bottom wall 18a and on the first clamping piston 11a; while
the second loading means 30b comprise at least one elastically compressible second loading element 32b which is arranged to abut on the second bottom wall 18b and on the second clamping piston 11b.

Even more specifically, the first clamping piston 11a defines at least a first tumbler cavity 33a wherein the first loading element 32a is at least partly housed.

Similarly, the second clamping piston 11b defines at least a second tumbler cavity 33b wherein the second loading element 32b is at least partly housed.

In actual facts, the first loading element 32a is arranged to stop on the bottom of the first tumbler cavity 33a and on the first bottom wall 18a, while the second loading element 32b is arranged to stop on the bottom of the second tumbler cavity 33b and on the second bottom wall 18b.

That said, it is specified that the first loading element 32a and the second loading element 32b are of the spring type, e.g., helical springs.

Therefore, the preload force generated by the first loading means 30a on the first clamping piston 11a and by the second loading means 30b on the second clamping piston 11b correspond to the spring force stored by the first loading element 32a and by the second loading element 32b, respectively, due to their compression.

It is important to notice that the preload force operating on the first clamping piston 11a and on the second clamping piston 11b reduces the pressurization time of the same (i.e., the speed with which they bring the gripping means 7 from the clamping/release configuration to the release/clamping configuration) to an extent proportional to its intensity.

This means that as the preload force operating on the first clamping piston 11a and on the second clamping piston 11b increases, the time required for the latter to complete their stroke inside the first housing 13a and the second housing 13b, respectively, decreases, and vice versa.

In actual facts, an inverse proportionality relationship exists between the preload force operating on the clamping pistons 11a, 11b and the pressurization time of the latter.

It is easy to appreciate that the frictional forces operating on the various clamping pistons 11a, 11b have, of course, different intensities between them, but still share the fact that they have opposite direction to their respective preload force.

In other words, a certain friction force due to the seals 14 and a preload force due to the respective loading means 30 operate on each clamping piston 11a, 11b, the two forces lying on the same direction of work D1, D2 and having opposite way.

It follows that adjusting the value of the preload force operating on each clamping piston 11a, 11b allows any differences between the frictional forces operating on the clamping pistons themselves to be corrected; thus, the clamping pistons 11a, 11b can take substantially the same amount of time to pressurize, causing their respective gripping jaws 7a, 7b to lie on the workpiece substantially simultaneously.

For this specific purpose, the friction compensation assembly 30, 31 comprises adjustment means 31 for adjusting the preload force which are associated with the bottom walls 18a, 18b and/or with the clamping pistons 11a, 11b and are adapted to adjust the distance between the bottom walls 18a, 18b and the relevant clamping pistons 11a, 11b in the release configuration.

Preferably, the adjustment means 31 are associated with the bottom walls 18a, 18b.

Thus, the adjustment means 31 allow the first bottom wall 18a to be moved close to/away from the first clamping piston 11a and the second bottom wall 18b to the second clamping piston 11b, proportionally increasing/decreasing the compression of the first loading element 32a and of the second loading element 32b, respectively.

It is easy to appreciate how greater/lesser compressions of the loading elements 32a, 32b result in greater/lesser preload forces exerted by them on the respective clamping pistons 11a, 11b.

Therefore, once it has been determined which of the two gripping jaws 7a, 7b ends its stroke first, it is sufficient to adjust the adjustment means 31 accordingly, i.e., increasing the preload force operating on the slower gripping jaw 7a, 7b or reducing the preload force operating on the faster gripping jaw 7a, 7b.

Ultimately, the adjustment means 31 make it possible to vary the resultant force operating on the clamping pistons 11a, 11b and, therefore, on the gripping jaws 7a, 7b; this implementation expedient makes it possible, with a few simple adjustments described below, to effectively compensate for the different frictions operating on the clamping pistons 11a, 11b regardless of their intensity and/or difference, making it possible to obtain a device 1 with a precise, reliable and efficient operation.

Specifically, the adjustment means 31 advantageously comprise:
at least one first adjustment pin 34a arranged at least partly within the first inlet chamber 17a and provided with at least one first abutment 35a coinciding with the first bottom wall 18a; and
at least one second adjustment pin 34b arranged at least partly within the second inlet chamber 17b and provided with at least one second abutment 35b coinciding with the second bottom wall 18b;
the adjustment pins 34a, 34b being adjustable in position along the directions of work D1, D2 to reduce and increase the distance between the bottom walls 18a, 18b and the clamping pistons 11a, 11b, respectively, in the release configuration.

Specifically, the first adjustment pin 34a is aligned with the first direction of work D1 and the second adjustment pin 34b is aligned with the second direction of work D2.

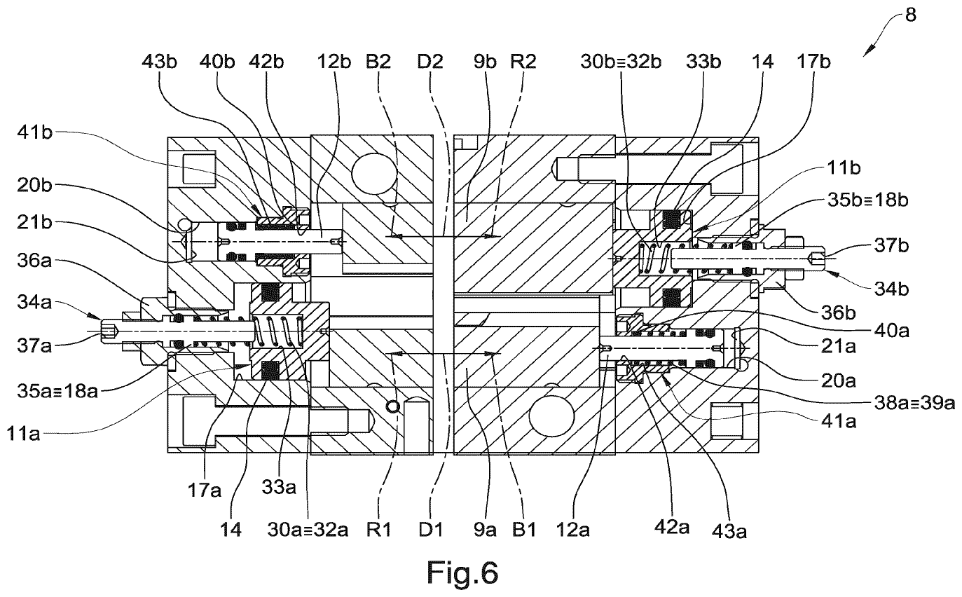

As mentioned, each adjustment pin 34a, 34b is adjustable in position along their respective directions of work D1, D2; for this purpose, the adjustment means 31 comprise at least a first adjustment body 36a within which the first adjustment pin 34a is at least partly fitted and at least a second adjustment body 36b within which the second adjustment pin 34b is at least partly fitted (see FIG. 6 in this regard).

Specifically, the adjustment pins 34a, 34b slide, along their respective directions of work D1, D2, with respect to the corresponding adjustment bodies 36a, 36b. To enable such sliding, the adjustment pins 34a, 34b and the adjustment bodies 36a, 36b are coupled to each other in a threaded manner.

This means that the adjustment pins 34a, 34b and the adjustment bodies 36a, 36b are provided with mutually associated threaded portions to make helical couplings between the first adjustment pin 34a and the first adjustment body 36a and between the second adjustment pin 34b and the second adjustment body 36b.

To allow the adjustment pins 34a, 34b to slide with respect to the adjustment bodies 36a, 36b, the first adjustment pin 34a is provided with at least a first adjustable dowel 37a and the second adjustment pin 34b is provided with at least a second adjustable dowel 37b.

Specifically, by operating on the adjustable dowels 37a, 37b (by means of special adjusting wrenches of the type, e.g., of Allen wrenches), it is possible to adjust the position of the adjustment pins 34a, 34b along the respective directions of work D1, D2, by compressing/decompressing the loading elements 32a, 32b and increasing/decreasing, therefore, the preload force operating on the clamping pistons 11a, 11b.

On the other hand, regarding the stroke adjustment of the release pistons 12a, 12b, the movement unit 8 comprises:
first return means 38a associated with the first release piston 12a;
second return means 38b associated with the second release piston 12b;
wherein the release pistons 12a, 12b are movable from a retracted position to an extended position as a result of filling the respective introduction chambers 20a, 20b with the pressurized fluid, and wherein the return means 38a, 38b are adapted to move the release pistons 12a, 12b from the extended position to the retracted position as a result of discharging the pressurized fluid from the respective introduction chambers 20a, 20b.

Specifically:
the first return means 38a comprise at least one elastically compressible first return element 39a which is arranged in abutment on the first release piston 12a and on at least one first abutment portion 40a of the basic body 2;
the second return means 38b comprise at least one elastically compressible second return element 39b which is arranged in abutment on the second release piston 12b and on at least one second abutment portion 40b of the basic body 2.

In actual facts, the return elements 39a, 39b are of the spring type, e.g., helical springs.

From the description just given, it is easy to appreciate that the return elements 39a, 39b are compressed more and more intensely as the release pistons 12a, 12b move forward from the retracted position to the extended position (i.e., at the same time as the filling of the introduction chambers 20a, 20b and the emptying of the inlet chambers 17a, 17b), exerting increasing forces on the latter.

These forces are, however, less than the thrust given on the release pistons 12a, 12b by the pressurized fluid, which is why the latter can move forward from the retracted position to the extended position.

In this circumstance, the thrust exerted on the first release piston 12a by the pressurized fluid causes it to push the first clamping piston 11a along the first way of release R1, that is, moving it away from the first slider 9a and moving it close to the first bottom wall 18a.

Similarly, the thrust exerted on the second release piston 12b by the pressurized fluid causes it to push the second clamping piston 11b along the second way of release R2, that is, away from the second slider 9b and close to the second bottom wall 18b.

After the pressurized fluid has been discharged from the introduction chambers 20a, 20b and its thrust on the release pistons 12a, 12b has ceased, the elastic energy stored by the return elements 39a, 39b is no longer counterbalanced by any force and is, therefore, released on the release pistons 12a, 12b by making them slide along their respective ways of clamping B1, B2 and returning them to their retracted position.

From the description just given, therefore, it is clear that the release pistons 12a, 12b and the clamping pistons 11a, 11b are of the single-acting piston type.

Regarding the above-mentioned abutment portions 40a, 40b, it should be specified that the movement unit 8 comprises at least a first supporting body 41a of the first release piston 12a which is precisely provided with the first abutment portion 40a.

Similarly, the movement unit 8 comprises at least a second supporting body 41b of the second release piston 12b which is precisely provided with the second abutment portion 40b.

Specifically, the first supporting body 41a comprises at least a first supporting hole 42a, made on the first abutment portion 40a, within which the first release piston 12a slides.

Similarly, the second supporting body 41b comprises at least a second supporting hole 42b, made on the second abutment portion 40b, within which the second release piston 12b slides.

Specifically, the first supporting body 41a is made hollow and defines, within itself, at least a first tumbler portion 43a, bounded at the bottom by the first abutment portion 40a, wherein the first return element 39a is at least partly contained.

Again, the second supporting body 41b is made hollow and defines, within itself, at least a second tumbler portion 43b, bounded at the bottom by the second abutment portion 40b, wherein the second return element 39b is at least partly contained.

It is worth explaining at this point that providing return means 38a, 38b of the release pistons 12a, 12b turns out to be a rather advantageous technical expedient to allow fine adjustment of the preload forces operating on the clamping pistons 11a, 11b and to obtain, therefore, a device 1 with precise and systematic operation.

In fact, the spring force exerted by the return elements 39a, 39b on the release pistons 12a, 12b allows, following the release of the pressurized fluid from the introduction chambers 20a, 20b, the release pistons 12a, 12b to be returned totally independently from the extended position to the retracted position, without, that is, the clamping pistons 11a, 11b having to intervene in any way.

In other words, the only components responsible for exerting the forces necessary to return the release pistons 12a, 12b from the extended position to the retracted position are precisely the return elements 39a, 39b and not, therefore, the clamping pistons 11a, 11b.

Otherwise, i.e., in the absence of the return means 38a, 38b, the preload force exerted by the loading elements 32a, 32b on the clamping pistons 11a, 11b must be enough to ensure that the latter also displace, together with the sliders 9a, 9b, the release pistons 12a, 12b as well along their respective ways of clamping B1, B2, thus bringing them back from the extended position (corresponding to the release configuration) to the retracted position (corresponding to the clamping configuration).

In the case of the present invention, on the other hand, the preload forces generated by the loading means 30 only have to compensate for the frictions operating on the release pistons 12a, 12b; as a result, the adjustments to be made on the loading means 30 are little and of limited magnitude overall, and the latter can, therefore, make fine adjustments on the clamping pistons 11a, 11b.

By enabling the release pistons 12a, 12b to be independently returned from the extended position to the retracted position, the return means 38a, 38b evidently work in synergy with the friction compensation assembly 30, 31 in enabling smooth, precise and effective adjustment of the operation of the gripping means 7.

All in all, the technical arrangements described so far concur in devising a device 1 which is absolutely versatile in its use and has efficient and accurate operation, which can therefore be used to clamp workpieces on a machine tool with extreme precision and repeatability.

It has in practice been ascertained that the described invention achieves the intended objects.

In particular, the fact is emphasized that the special expedient of providing friction compensation means makes it possible to have the gripping jaws laid on a workpiece substantially simultaneously, that is, ensuring that the clamping pistons are pressurized with the same timing.

In this way, it is clearly possible to obtain a device for clamping workpieces on machine tools with precise and reliable operation which allows the workpiece to be clamped stably on a machine tool without deforming it.

1. Device for clamping workpieces on machine tools, comprising:
at least one basic body which can be fastened to a machine tool;
gripping means of a workpiece to be machined associated with said basic body, comprising at least one first gripping jaw and at least one second gripping jaw and movable between at least one clamping configuration of said workpiece, wherein said gripping jaws are mutually approached, and at least one release configuration of said workpiece, wherein said gripping jaws are mutually moved away with respect to said clamping configuration;
at least one movement unit which is associated with said basic body and is adapted to move said gripping means between said clamping configuration and said release configuration, comprising:
at least one first slider sliding along at least one first direction of work and associated with said first gripping jaw;
at least one first clamping piston operatively associated with said first slider and movable, due to the thrust of at least one pressurized fluid, to allow said first slider and said first gripping jaw to slide along at least one first way of clamping moving close to said second gripping jaw;
at least one first release piston operatively associated with said first slider and movable, due to the thrust of said pressurized fluid, to allow said first slider and said first gripping jaw to slide along at least one first way of release, opposite said first way of clamping, away from said second gripping jaw;
at least one second slider sliding along at least one second direction of work parallel to said first direction of work and associated with said second gripping jaw;
at least one second clamping piston operatively associated with said second slider and movable, due to the thrust of said pressurized fluid, to allow said second slider and said second gripping jaw to slide along at least one second way of clamping moving close to said first gripping jaw; and
at least one second release piston operatively associated with said second slider and movable, due to the thrust of said pressurized fluid, to allow said second slider and said second gripping jaw to slide along at least one second way of release, opposite said second way of clamping, moving away from said first gripping jaw;
wherein said movement unit comprises at least one friction compensation assembly associated with said clamping pistons.

2. Device according to claim 1,
wherein said friction compensation assembly comprises first loading means associated with said first clamping piston and second loading means associated with said second clamping piston, said loading means being adapted to exert on said clamping pistons at least one preload force having a direction substantially parallel to said directions of work and a way concordant with said ways of clamping.

3. Device according to claim 2,
wherein:
said movement unit comprises:
at least one first inlet chamber of said pressurized fluid bounded by said first clamping piston and by at least one first bottom wall; and
at least one second inlet chamber of said pressurized fluid bounded by said second clamping piston and by at least one second bottom wall;
said first loading means comprise at least one elastically compressible first loading element which is arranged to abut on said first bottom wall and on said first clamping piston;
said second loading means comprise at least one elastically compressible second loading element which is arranged to abut on said second bottom wall and on said second clamping piston.

4. Device according to claim 3,
wherein said friction compensation assembly comprises adjustment means for adjusting said preload force which are associated with said bottom walls and/or with said clamping pistons and are adapted to adjust the distance between said bottom walls and the relevant said clamping pistons in said release configuration.

5. Device according to claim 4,
wherein said adjustment means comprise:
at least one first adjustment pin arranged at least partly within said first inlet chamber and provided with at least one first abutment coinciding with said first bottom wall; and
at least one second adjustment pin arranged at least partly within said second inlet chamber and provided with at least one second abutment coinciding with said second bottom wall;
said adjustment pins being adjustable in position along said directions of work.

6. Device according to claim 1, wherein said movement unit comprises:
at least one first introduction chamber of said pressurized fluid bounded by said first release piston and by at least one first bottom surface;
at least one second introduction chamber of said pressurized fluid bounded by said second release piston and by at least one second bottom surface;
first return means associated with said first release piston; and
second return means associated with said second release piston;
wherein said release pistons are movable from a retracted position to an extended position as a result of filling the respective said introduction chambers with said pressurized fluid, and wherein said return means are adapted to move said release pistons from said extended position to said retracted position as a result of discharging said pressurized fluid from said respective introduction chambers.

7. Device according to claim 6,
wherein:
said first return means comprise at least one elastically compressible first return element which is arranged in abutment on said first release piston and on at least one first abutment portion of said basic body; and by the fact that
said second return means comprise at least one elastically compressible second return element which is arranged in abutment on said second release piston and on at least one second abutment portion of said basic body.

8. Device according to claim 1, wherein it comprises stopping means associated with said basic body and comprising at least one stopping piston which is movable along at least one direction of stopping (A) substantially orthogonal to said directions of work and is adapted to clamp said sliders by friction in said clamping configuration.

9. Device according to claim 8,
wherein:
said first slider and said second slider comprise at least one first indented portion and at least one second indented portion respectively, said indented portions being juxtaposed with each other to define at least one internal space (S) between said sliders; and by the fact that
said stopping piston is provided with at least one enlarged portion which can be inserted into said space (S) to clamp said sliders.

10. Device according to claim 9,
wherein said stopping means comprise at least one elastically compressible thrust element which is positioned between said stopping piston and said basic body and is adapted to impart on said stopping piston at least a direct thrust force along said direction of stopping (A).

11. Device according to claim 2, wherein said movement unit comprises:
at least one first introduction chamber of said pressurized fluid bounded by said first release piston and by at least one first bottom surface;
at least one second introduction chamber of said pressurized fluid bounded by said second release piston and by at least one second bottom surface;
first return means associated with said first release piston; and
second return means associated with said second release piston;
wherein said release pistons are movable from a retracted position to an extended position as a result of filling the respective said introduction chambers with said pressurized fluid, and wherein said return means are adapted to move said release pistons from said extended position to said retracted position as a result of discharging said pressurized fluid from said respective introduction chambers.

12. Device according to claim 3, wherein said movement unit comprises:
at least one first introduction chamber of said pressurized fluid bounded by said first release piston and by at least one first bottom surface;
at least one second introduction chamber of said pressurized fluid bounded by said second release piston and by at least one second bottom surface;
first return means associated with said first release piston; and
second return means associated with said second release piston;
wherein said release pistons are movable from a retracted position to an extended position as a result of filling the respective said introduction chambers with said pressurized fluid, and wherein said return means are adapted to move said release pistons from said extended position to said retracted position as a result of discharging said pressurized fluid from said respective introduction chambers.

13. Device according to claim 4, wherein said movement unit comprises:
at least one first introduction chamber of said pressurized fluid bounded by said first release piston and by at least one first bottom surface;
at least one second introduction chamber of said pressurized fluid bounded by said second release piston and by at least one second bottom surface;
first return means associated with said first release piston; and
second return means associated with said second release piston;
wherein said release pistons are movable from a retracted position to an extended position as a result of filling the respective said introduction chambers with said pressurized fluid, and wherein said return means are adapted to move said release pistons from said extended position to said retracted position as a result of discharging said pressurized fluid from said respective introduction chambers.

14. Device according to claim 5, wherein said movement unit comprises:
at least one first introduction chamber of said pressurized fluid bounded by said first release piston and by at least one first bottom surface;
at least one second introduction chamber of said pressurized fluid bounded by said second release piston and by at least one second bottom surface;
first return means associated with said first release piston; and
second return means associated with said second release piston;
wherein said release pistons are movable from a retracted position to an extended position as a result of filling the respective said introduction chambers with said pressurized fluid, and wherein said return means are adapted to move said release pistons from said extended position to said retracted position as a result of discharging said pressurized fluid from said respective introduction chambers.

15. Device according to claim 2, wherein it comprises stopping means associated with said basic body and comprising at least one stopping piston which is movable along at least one direction of stopping (A) substantially orthogonal to said directions of work and is adapted to clamp said sliders by friction in said clamping configuration.

16. Device according to claim 3, wherein it comprises stopping means associated with said basic body and comprising at least one stopping piston which is movable along at least one direction of stopping (A) substantially orthogonal to said directions of work and is adapted to clamp said sliders by friction in said clamping configuration.

17. Device according to claim 4, wherein it comprises stopping means associated with said basic body and comprising at least one stopping piston which is movable along at least one direction of stopping (A) substantially orthogonal to said directions of work and is adapted to clamp said sliders by friction in said clamping configuration.

18. Device according to claim 5, wherein it comprises stopping means associated with said basic body and comprising at least one stopping piston which is movable along at least one direction of stopping (A) substantially orthogonal to said directions of work and is adapted to clamp said sliders by friction in said clamping configuration.

19. Device according to claim 6, wherein it comprises stopping means associated with said basic body and comprising at least one stopping piston which is movable along at least one direction of stopping (A) substantially orthogonal to said directions of work and is adapted to clamp said sliders by friction in said clamping configuration.

20. Device according to claim 7, wherein it comprises stopping means associated with said basic body and comprising at least one stopping piston which is movable along at least one direction of stopping (A) substantially orthogonal to said directions of work and is adapted to clamp said sliders by friction in said clamping configuration.
